(19) United States
(12) Patent Application Publication
(10) Pub. No.: US 2005/0154563 A1
(43) Pub. Date: Jul. 14, 2005

(54) Device and method for evaluating a characteristic of an object

(76) Inventors: Ulf Hassler, Heilsbronn (DE); Steven Oeckl, Erlangen (DE); Thomas Wenzel, Baiersdorf (DE); Randolf Hanke, Puschendorf (DE); Guenther Kostka, Erlangen (DE)

Correspondence Address: GLENN PATENT GROUP, 3475 EDISON WAY, SUITE L, MENLO PARK, CA, 94025, US

(21) Appl. No.: 10/488,313

(22) Filed: Feb. 27, 2004

Related U.S. Application Data
(63) Continuation of application No. PCT/EP02/09519, filed on Aug. 26, 2002.

(30) Foreign Application Priority Data
Aug. 27, 2001 (DE) 10141807.8

(51) Int. Cl. G06F 17/00

(52) U.S. Cl. 702/189

(57) ABSTRACT

An apparatus for evaluating a state of an object includes a means for providing a three-dimensional representation of the object including information about the state to be evaluated. The three-dimensional representation is then subdivided into a plurality of sub-areas that are subsequently evaluated sub-area by sub-area, namely by two-dimensionally examining each sub-area of the plurality of sub-areas, in order to ascertain data about a place in a sub-area at which the state deviates from a default state. A three-dimensional connection analysis using the data about the places from the individual sub-areas provides a three-dimensional description of a three-dimensional place whose state deviates from the default state. By splitting up the three-dimensional representation into several sub-areas that may be analyzed two-dimensionally, powerful image processing algorithms may be employed. The three-dimensionality is then again achieved by means of a connection analysis of the two-dimensional data. Thus it may be done without a geometric reference model as well as the accompanying requirement for memory and computation time.

### CROSS-REFERENCE TO RELATED APPLICATION

This application is a continuation of co-pending International Application No. PCT/EP02/09519, filed Aug. 26, 2002, which designated the United States and was not published in English.

### BACKGROUND OF THE INVENTION

1. Field of the Invention

The present invention relates to the material testing and in particular to the non-destructive evaluation of a state of an object.

b 2. Description of the Related Art

The technical field of application of the method described here is the industrial quality control on products whose spatial density distribution can be digitally represented by means of methods of the 3D tomography (X-ray or magnetic resonance) or other methods. The control takes place with respect to the test for factory flaws, which are emerging as porosity, crack, in general as deviation from a default density or material value. As one of the most important cases of application, the detection of porosities in aluminum castings is to be mentioned. The particular difficulty in the detection of such flaw features lies in the fact that, in the object to be tested, usually other constructive features are introduced at the same time, whose extent may be on the same order as the flaw structure or the flaws to be detected. This results in the fact that simple threshold decisions do not lead to a unique discrimination between flaw and constructive feature.

In the production of devices, e.g. from aluminum/magnesium/steel/ceramics or plastics, there may be production flaws in the inner structure, which significantly affect the mechanical properties and thus the stability performance. A discard of such products is necessary. Such flaws may for example occur at material fluid mechanically disadvantageous positions and usually show by locally limited density differences/gradients relative to the undisturbed flawless distribution. The spatial extent of such defect structures may be comparable with the concurrently present constructive structures within test object, such as bores, channels, threads or writing/marking embossings. Especially in the prototype phase, i.e. in the optimizing of the production process, quick and reliable illustration of such inner defects is indispensable.

Up to now, in the industrial area, for this testing task in most cases either destructive or 2D radioscopy methods are employed, which can however only provide an unsatisfactory test depth due to the reasons stated in the following.

Destructive Methods:

The test objects are sawn up, or material is lifted off layer by layer in order to expose object structures of interest. These structures may then be measured by means of optical methods, e.g. microscopy. Apart from the required (time) effort, it is disadvantageous in these methods that the objects no longer exist in an intact way after the testing, whereby other testing methods, such as stress tests, can no longer be conducted. But it is exactly the association of defect size with stress that is just still tolerable that would result in substantial statements on the product properties.

2D Radioscopy:

The X-ray transmission test (radioscopy) is a versatile instrument in the non-destructive material testing and is employed as a standard in many areas, e.g. in the automatic light metal wheel testing. A substantial disadvantage of this method is, however, the loss of depth information arising in the projection of three-dimensional objects onto a two-dimensional detector area. Not only is spotting possible defects more difficult (or impossible) by the superimposition of all object structures onto a single plane, but also their exact localization and measurement is only possible in the most rare cases.

3D—CT—Manual/Visual:

In the last few years the X-ray computer tomography (CT) arrived on the scene in the development laboratories of the industry. By the capture of a multiplicity of projections of the test object from different directions, this technique enables a digital reconstruction of the spatial density distribution of the device under test. By means of suitable visualization software it is possible for the test personnel to lay arbitrary virtual sections into the object volume and thus measure internal structures of the object, constructive as well as faulty. This takes place interactively by means of the visualization tools, the assessment takes place visually or with corresponding measurement functions. Most of the time, this process is very time consuming, since the object volumes (typically 100 MB to 4 GB of data volume) have to be manually represented layer by layer and visually examined for local density variations. This is to be taken into account especially with respect to latest developments in the area of 3D CT. There, highly optimized 3D methods are increasingly used, with which the capture and reconstruction of object volumes is possible within fewer minutes (3-5 minutes). Up to about two years ago, such measuring processes took hours. Here, the problem arises that, in general, the manual (visual) evaluation cannot keep pace with the measurement/reconstruction process temporarily.

3D CT Matching with CAD Data:

More recent developments in the material testing by means of CT aim for comparison of the reconstructed object volumes with an existing CAD model of the device under test, whereby not only internal defects, such as porosities, pipes, etc., can be detected, but also testing of the accuracy to gage of e.g. wall thicknesses, bores, etc. is possible. For this, in a first step a facet model that substantially represents the surface contour of the device under test is generated from the reconstructed object volume. In a second step, the transformation matrix between facet model and CAD model is calculated (registration). For this, usually use is made of some selected (or specially attached for this purpose) prominent structures of the object. A third and last step is the calculation of the deviations of the facet model from the CAD model.

Although a test object may theoretically be exactly measured with this technique, some disadvantages exist: a) Up to now no continuous process chain exists that allows automized measurement without intensive interaction with the test personnel. b) Problems mainly exist in the exact extraction of the device surface and in the subsequent registration. c) The calculation of the facet model and the registration involves an extreme amount of storage and calculation time. d) The last and maybe substantial disadvantage is the fact that the CAD model describes the finished product, but a blank comes from the foundry, which in many places contains material additions that are not removed until further procedural steps. By these circumstances, the process of the registration is made significantly more difficult. Testing for internal material flaws directly after the casting process might therefore prove to be difficult with this technique, which leads to time losses and perhaps to some machining steps conducted in vain.

In summary, the known methods are thus disadvantageous in that especially when a reference object is provided, the amounts of data to be processed are so enormous that this method is not feasible for an automized environment, which is particularly further aggravated when, as it has been stated, blanks are to be examined, for which there is not even a special CAD model, since this only exists for the finished end product. Especially the quality control after each production step, i.e. with the blank and not with the finished end product, is particularly of interest, since when a blank can already be discarded, no unnecessary processing steps have to be invested into a product that is faulty from the beginning. Early quality control and selection of flaws is critical for cost reduction.

WO 01/54065 A1 discloses a method, system and computer-readable medium for the two-dimensional and three-dimensional detection of lung lumps using computerized tomography scans. From a three-dimensional CT capture of the thorax, at first the lung itself is identified and extracted. The segmented lung regions for all sections in a CT scan form a complete segmented lung volume that is subjected to a subsequent analysis. Then the segmented lung volume from which also artifacts are taken off is processed such that 36 threshold value lung volumes are created. To this end, a gray scale record of a complete segmented lung volume is subjected to a threshold value decision with 36 different threshold values each. For each threshold value lung volume a three-dimensional 18 point connection scheme is then conducted in order to examine for each pixel of the complete segmented lung volume whether it belongs to a volume or not. Here, it is examined for each pixel whether the 18 adjacent pixels have the same value. If this question is answered in the affirmative, the pixel is designated belonging to the volume. Some of the adjacent pixels lie in the CT section above with reference to the examined pixel or the CT section below. With this, individual structures within all 36 threshold value volumes may be identified. The geometric volume of each individual structure is then calculated by multiplying the number of pixels obtained within the structure by a known volume element (voxel). Lung lumps have a maximum upper volume. U.S. Pat. No. 5,838,815 and U.S. Pat. No. 5,627,907 disclose a method for detecting an abnormal region in living tissue that is represented by digital radiography, wherein at first a suspicious abnormal region is identified in the radiography in order to then extract several topographic layers of the suspicious abnormal region from the digital radiography, wherein the several topographic layers are extracted from the same radiography. Then features of the region of each of the layers are determined to finally apply a criterion extending across the topographic layers to the features in order to determine whether the suspicious abnormal region is indeed an abnormal region.

U.S. Pat. No. 4,985,834 discloses a method for creating respective two-dimensional images from a three-dimensional representation.

EP 0 875 751 A1 discloses a three-dimensional computer tomography method for examining and comparing a current geometry with a predetermined geometry of an object. To this end, the object is scanned three-dimensionally to obtain several slices of actual geometry data of the object. Then the several slices are processed into actual boundary data defining the inner and outer boundaries of the object. Finally, actual point cloud data are created from the actual boundary data. Furthermore, the actual point cloud data are compared with predetermined object geometry data, wherein an image is created that reflects the mismatch between the point cloud data and the predetermined data.

### SUMMARY OF THE INVENTION

It is the object of the present invention to provide a concept for evaluating a state of an object, which works in a secure and economic manner.

In accordance with a first aspect, the present invention provides an apparatus for evaluating a state of an object, having: means for providing a three-dimensional representation of the object including information about the state to be evaluated; means for subdividing a three-dimensional representation into a plurality of sub-areas, wherein a sub-area includes volume elements; means for two-dimensionally evaluating sub-area by sub-area the three-dimensional representation by examining each sub-area of the plurality of sub-areas in order to ascertain data about one or more two-dimensional places in the sub-area at which the state deviates from a default state; and means for performing a three-dimensional connection analysis using the data about the places by tracking connected places through the individual sub-areas and linking the connected places in order to obtain a three-dimensional description of one or more three-dimensional places whose states deviate from the default state, characterized in that the means for subdividing the three-dimensional representation into sub-areas is disposed to perform a subdivision in at least two different directions through the three-dimensional representation, the means for two-dimensionally evaluating the sub-areas is disposed to examine the sub-areas segmented in different directions such that for each volume element of the three-dimensional representation at least two separate pieces of information about a deviating state are obtained, and means for linking the at least two pieces of information present per volume element, which precedes the means for the three-dimensional connection analysis in order to specify by linking the pieces of information, whether a volume element includes a state deviating from the default state or an artifact.

In accordance with a second aspect, the present invention provides a method for evaluating a state of an object, having the steps of: providing a three-dimensional representation of the object, which includes information about the state to be evaluated; subdividing the three-dimensional representation into a plurality of sub-areas, wherein a sub-area includes volume elements; two-dimensionally evaluating sub-area by sub-area the three-dimensional representation by examining each sub-area of the plurality of sub-areas, in order to ascertain data about one or more two-dimensional places in the sub-area at which the state deviates from a default state; and performing a three-dimensional connection analysis using the data about the places for the individual sub-areas by tracking connected places through the individual sub-areas and linking the connected places in order to obtain a three-dimensional description of one or more three-dimensional places whose states deviate from the default state, characterized in that in the step of subdividing the three-dimensional representation into sub-areas, a subdivision is performed in least two different directions through the three-dimensional representation, in the step of two-dimensionally evaluating the sub-areas, the sub-areas segmented in different directions are examined such that for each volume element of the three-dimensional representation at least two separate pieces of information about a deviating state are obtained, and before the step of conducting the three-dimensional connection analysis, the step of linking the at least two pieces of information present per volume element is performed, in order to specify, by linking the pieces of information, whether a volume element includes a state deviating from the default state or an artifact.

The present invention is based on the finding that a three-dimensional evaluation of the state of an object may be achieved in that, starting from a three-dimensional representation of the object, at first a three-dimensional representation is subdivided into sub-areas, whereupon, for each sub-area, a two-dimensional analysis of its own with respect to the state of the object to be examined, e.g. the density of the object, is conducted. The two-dimensional analysis of sub-areas, which preferably are layers of the three-dimensional representation, provides specifications on state inhomogeneities for each sub-area. By means of a three-dimensional connection analysis on the result from the individual layers, an area of the object may then be detected three-dimensionally by the state of the object deviating from a predetermined state.

It is the advantage of the present invention that no reference data like in the reference CAD analysis are required, that only due to the three-dimensional representation of the object to be examined deviations in state may be determined. A further advantage of the present invention is that by conducting a two-dimensional analysis sub-area by sub-area powerful image processing algorithms may be employed to recognize deviations from a default state two-dimensionally.

A further advantage of the present invention is that the inventive connection analysis does no longer have to be performed across the entire image data, but only across data having been marked as deviations in the two-dimensional analysis sub-area by sub-area.

Furthermore, the three-dimensional connection analysis has the advantage that result data of the individual layers or sub-areas are brought into connection. While an artifact, i.e. a value for a deviating state marked in a two-dimensional layer, although the object does not have a deviating state at this place, is not recognizable due to a two-dimensional analysis alone, this artifact is in some way automatically filtered out due to the three-dimensional connection analysis. With sufficiently fine layer division, an artifact is recognized if it does not have a correspondingly marked area in the layer above and/or below at the same geometric position. If thus the layer division is made sufficiently fine, namely so fine that material disorders that are smaller than the height of a layer are not to be detected, the connection analysis alone already enables a robust artifact filtering, which is especially of great significance if no reference CAD data are available. Statements on the state of the object have to be obtained on the basis of the existing three-dimensional representation of the object alone and, if necessary, auxiliary data about default states etc.

A further advantageous feature of the connection analysis, and in particular of the three-dimensional characterization of areas with deviating state, is that arbitrary attributes of a deviation may be calculated, by means of which deviations from a default state may be classified with reference to whether they are constructive, i.e. bores or inner cavities with certain structure, or they are faulty areas, i.e. air inclusions, porosities or areas in which there is for example lower material density than specified.

### BRIEF DESCRIPTION OF THE DRAWINGS

These and other objects and features of the present invention will become clear from the following description taking in conjunction with the accompanying drawings, in which:

FIG. 1 is a block circuit diagram of an inventive apparatus for evaluating a state of an object;

FIG. 2 is a schematic illustration of a three-dimensional representation of an object for the elucidation of the subdivision in one direction;

FIG. 3 is a schematic illustration of a three-dimensional representation of the object for the elucidation of a subdivision in three directions;

FIG. 4 is a more detailed illustration of the functionality of the means for two-dimensionally evaluating the sub-areas;

FIG. 5 is a flow chart illustration of the inventive method according to a preferred embodiment; and

FIG. 6 is a flow chart illustration of the inventive concept according to a further preferred embodiment with subdivision in the three axis directions.

### DESCRIPTION OF THE PREFERRED EMBODIMENTS

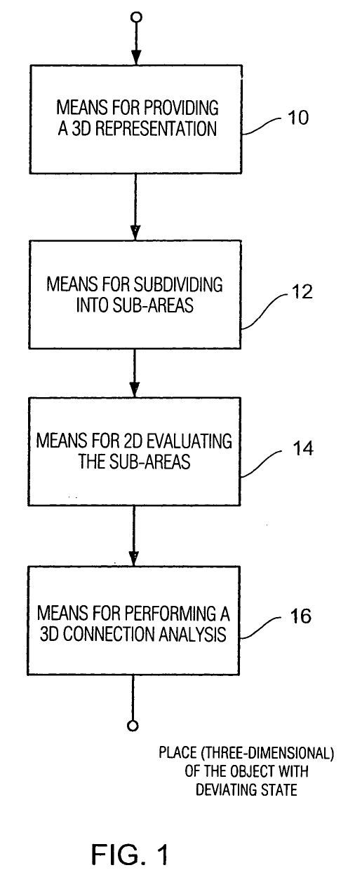

FIG. 1 shows a block diagram of the inventive apparatus for evaluating a state of an object. The preferred state of the object to be examined is the density of the object. However, with the inventive method, arbitrary other states, such as material parameters etc., may be detected as long as information about such states can be taken from a three-dimensional representation of the object. The inventive apparatus, as it is shown in FIG. 1, first includes means 10 for providing a three-dimensional representation of the object from which state information about the object may be taken. The three-dimensional representation is fed to means 12 for subdividing the object to render the three-dimensional object representation for two-dimensional evaluation by means 14 for two-dimensionally evaluating the sub-areas downstream of means 12.

Means 14 operates to perform a two-dimensional evaluation sub-area by sub-area of the three-dimensional representation. In each sub-area of the plurality of sub-areas, the data of the respective sub-area is examined to determine information about a place of the sub-area at which the state of the object deviates from a default state. In the example of a density examination, this means that, at the place that is determined for a sub-area by means 14, the density deviates downward. This would indicate an air inclusion, a pore, or also a constructive structure, such as a bore.

An upward deviation of the density, however, may be an indication for an enclosed foreign body, e.g. an iron chip in aluminum.

After the means 14 has performed its analysis for all sub-areas, the obtained information about places in the sub-areas with deviating state is fed to a means 16. Means 16 is formed to perform a three-dimensional connection analysis using the data about the places from the individual layers. The connection analysis will provide a three-dimensional description of a three-dimensional place the state of which deviates from the default state.

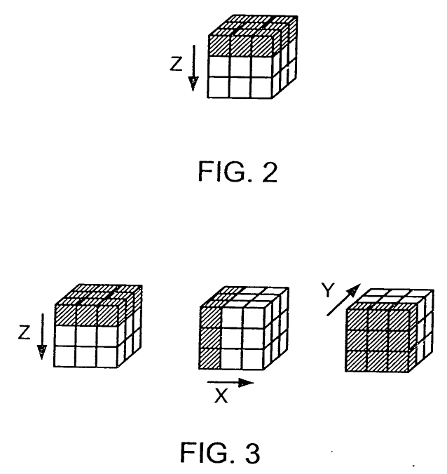

Depending on the type of the data of the three-dimensional representation of the object provided by the means 10, means 12 is disposed to subdivide the three-dimensional representation into sub-areas. If the three-dimensional representation is present as xyz representation, means 12 is preferably formed to subdivide the three-dimensional representation into layers. This is illustrated on the basis of FIG. 2. Only for illustration purposes, a cube with 27 volume elements also designated in the art as voxel is illustrated. FIG. 2 shows a subdivision into layers along the z direction such that each layer is regarded as two-dimensional representation in the xy plane.

As to be seen from FIG. 3, however, subdivisions of the three-dimensional representation along the x direction are also possible and make sense. In this alternative, the layers are present as layers in the yz plane. Finally, the three-dimensional representation may also be subdivided along the y direction, two-dimensional layers then being present in the xz plane.

If the three-dimensional representation is on the other hand given in a cylindrical coordinate system or a spherical coordinate system, a layer division along the main coordinates radius, angle and height, or radius, azimuthal angle and elevational angle, respectively, then present may be also selected. In general, means 12 is disposed to subdivide the three-dimensional representation of the object into several sub-areas that are accessible for a two-dimensional evaluation or analysis. This feature is of advantage in so far as known and powerful image processing algorithms may be employed to be able to perform analysis by layer or by sub-area of the three-dimensional volume data of the object.

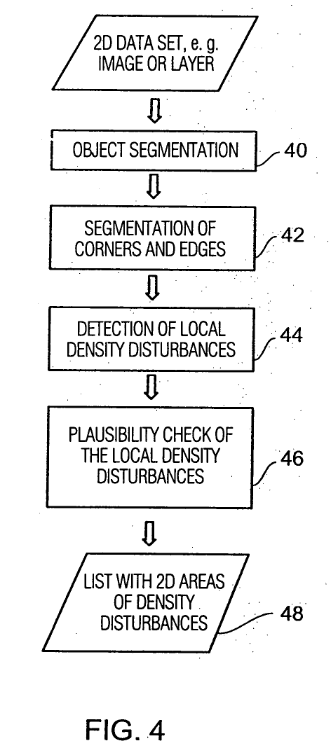

The inventive concept, which will be explained on the basis of FIGS. 4 to 6 in more detail, thus enables an as quick as possible influence on the process parameters underlying a production process as defined by a process check or process optimization. The results of the evaluation are supposed to enable a modification of the production parameters as quickly as possible to minimize the time need of a process adjustment or the amount of defectively produced parts. Therefore, in contrast to previous methods, according to the invention, the entire three-dimensional state distribution, e.g. density distribution, of the object is taken into consideration without using explicitly geometric (a priori) information about the object, which is possibly present as a three-dimensional CAD reference model—only for the finished end product.

The inventive concept thus enables quick and automatic testing of objects, such as castings or injection moldings, for internal production flaws, such as pipes, material inhomogeneities or porosities, without requiring geometric information of the reference model of the device, such as a three-dimensional CAD model.

According to the invention, now volume reconstructions of for example aluminum castings may be tested for internal material inhomogeneities automatically and without the assistance of the geometric information of reference models.

If present, geometric information, such as material parameters or density or also constructive details with respect to the size of bores to be expected, etc., may also be made available to the inventive concept. In this case, the inventive concept, without a full three-dimensional reference model being needed, is able to measure also constructive features of an object and classify into faulty and non-faulty.

In particular relative to the use of a three-dimensional reference model the following advantages are achieved:
1. Since no explicit reference model (e.g. CAD data) is used, the step of the registration can be omitted. This step is very time-intensive and prevents fully automatic evaluation, since an effective universally valid method without interactive user intervention does not exist, in particular in blanks (rough castings) with material additions that possibly have to be processed further. Only the renouncement of the step of the registration (calculation of the [relative] positional deviation from measured volume data to the geometric reference model [transformation matrix]) thus enables a fully automatic evaluation.
2. In the inventive evaluating method, both the step of the surface extraction as well as the registration can be omitted. Thereby, a substantial velocity gain may be accomplished, so that the evaluation times lie in the range of the currently fastest CT stations (about 5 minutes for capture and reconstruction for a 512×512×400 voxel size volume). Thus, a close-to-series (fully) automatic evaluation of data generated by means of volume CT is achieved for the first time.
3. Relative to evaluation by means of a geometric reference model, substantially smaller material inhomogeneities may be determined. In particular, porosity nests may be localized, whose individual pores may be smaller than the size of a reconstructed voxel (volume element). In evaluation with the aid of a geometric reference model, deviations (flaw structures) are determined on the basis of a comparison of the surface of the reference model with a device surface extracted from the reconstructed object volumes. Possible internal flaws can thus be determined by simple threshold operations (distinction of the density of material/air). This can only take place from a certain flaw size (>a voxel). The inventive concept, however, determines local density deviations and may thus also detect voids that do not show as cavity in the reconstructed volumes but as areas with density values that are locally slightly below the target values. For example, this is present when single pores whose expansion is smaller than the reconstructed voxel size are in the device.

As it is illustrated in FIG. 1, means 10 provides a three-dimensional representation of the object. The three-dimensional representation should be present in a real three-dimensional (volumetric) data format, i.e. in a voxel volume or tensor field of state values, such as density values. Such data may for example be created by methods of X-ray or magnetic resonance tomography.

All other data generation methods for a creation of a volumetric representation, e.g. ultrasound data etc., may also be employed.

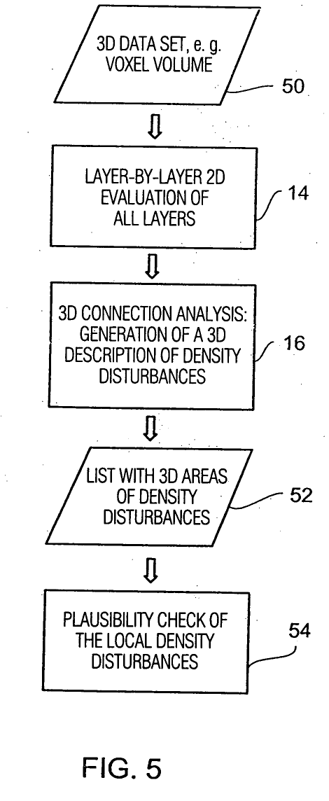

Subsequently, on the basis of FIG. 5, it will be gone into a preferred embodiment of the present invention. The three-dimensional data set, for example in form of a voxel volume 50, is subjected to a two-dimensional evaluation layer by layer of all layers 14. Then, by means of means 16, as it is illustrated in FIG. 5, a three-dimensional connection analysis is created, whereby a three-dimensional description of density disturbances is generated, i.e. of places of the object with deviating state. The three-dimensional connection analysis provides a list 52 with three-dimensional areas or places of density disturbances or of state deviations from a default state. Preferably, as it is illustrated in FIG. 5, a plausibility check 54 of the included three-dimensional density disturbances is then performed.

Before it is gone into the functional blocks shown in FIG. 5 in greater detail, at first reference is made to FIG. 4, in which an example for the design of the means 14 for two-dimensionally evaluating the sub-areas or, in the case of an orthogonal division, two-dimensional layers is performed. Means 14 requires as input information a two-dimensional data set 40 as image or layer. Then, preferably the principle of background modeling is employed, which is described in the publication of R. Hanke, U. Hassler, K. Heil: “Fast automatic X-ray image processing by means of a new multistage filter for background modelling”, IEEE Int. Conf. on Image Processing ICIP, Austin, USA, 1994. The prior art method for two-dimensional analysis describes the application of image processing methods for a radioscopic two-dimensional examination of aluminum castings. In this two-dimensional method, no reference model is used, but the principle of background modeling is employed.

According to the invention, at first an object segmentation is performed, i.e. the three-dimensional representation of the object to be examined is split into segments, to determine whether in the segment there is information about the object or background information or information about other objects not to be examined. Then, those image areas are marked that belong to the object to be examined. To this end, it makes sense to have at least information about the general appearance of the object. Then, the segmentation concept of means 40 may be adapted to the volume data to be examined. In general, pre-information, however, is not necessarily required. The object segmentation serves to roughly localize in an unknown graphical representation what is to be examined at all.

In a subsequent search for material inhomogeneities, this rough search enables to only examine the marked regions or segments, whereby a reduction of the data volume to be examined is achieved, which immediately results in an increase in evaluation velocity.

In a next step of the preferred method, the individual segments are segmented more accurately, namely by preferably outer corners and edges by a means 42 for the segmentation of corners and edges. This is achieved by applying a significance threshold, wherein gray scale deviations lying above the significance threshold, density values being represented by gray scale values, are examined more accurately in order to eliminate pseudo flaws that may also occur here already. To this end, corners and edges are detected by application of corresponding filters in the object area and marked as such. This enables further confinement of the data made available to a means 44 for the detection of local density disturbances. Means 44 is disposed to examine the layer to be examined, and in particular also the marked areas of the layer, with suitable filters for local density disturbances. Here, freely configurable significance thresholds may be used for density deviations to be examined, so that an optimum matching of the evaluation to a device to be tested is ensured. To achieve matching, data about the device should already exist beforehand to provide different density thresholds for castings on the one hand or soldering points etc. on the other hand. The inventive method is however also applicable without pre-information, wherein iteration steps could be provided here to gradually find out which states preferably occur. The provision of pre-information about information to be expected, however, improves the efficiency and accuracy of the inventive method.

Means 44 is further disposed to associate each detected place with a deviation in state with one or more attributes, such as size in pixels, strength, information about the surroundings of the (two-dimensional) place of deviating state, etc. A further attribute is of course the position of the place that may be indicated either implicitly or explicitly.

In an ensuing two-dimensional plausibility check 46 of the local density disturbances, i.e. the places with deviating state, from the amount of density disturbances found, e.g. those may already be erased whose attributes show the density disturbance as constructive feature of the object, e.g. as corner or edge. At the output of the two-dimensional data analysis, a list 48 with two-dimensional places of density disturbances is output. For the ensuing three-dimensional connection analysis (means 16 in FIGS. 1 and 5), it is preferred that each place of deviating state as an attribute further has the position in the volume indicated either absolutely or relatively to a reference point of the object.

Means 14 for two-dimensionally evaluating the sub-areas thus causes data transformations to the effect that at the input side a layer of arbitrary three-dimensional representation is present e.g. in form of pixels, and that at the output side no more pixel data are present in the preferred embodiment of the present invention, but only a list with the places of deviating state along with a multiplicity of possible attributes.

The previously described evaluation strategy is now applied to the measured object volume layer by layer. After all layers of the object volume have been run through, information about background, object, corners, edges, and in particular of defects in the object are present by layer. From the individual layers now a three-dimensional characterization of the object and the flaws detected therein is created by means of the connection analysis by tracking and linking together connected density deviations through the individual layers. Thereby a real three-dimensional description of object structures, be it flaws or destructive features such as bores, is achieved. The three-dimensional density disturbances are preferably associated with features or attributes that may include the volume of the three-dimensional place, the center of gravity, the mass, moments, form factors, kind and expansion of vicinities of the three-dimensional places, etc. With the aid of this description a statement may then be made about the quality of the object to be inspected by means of typically default test criteria.

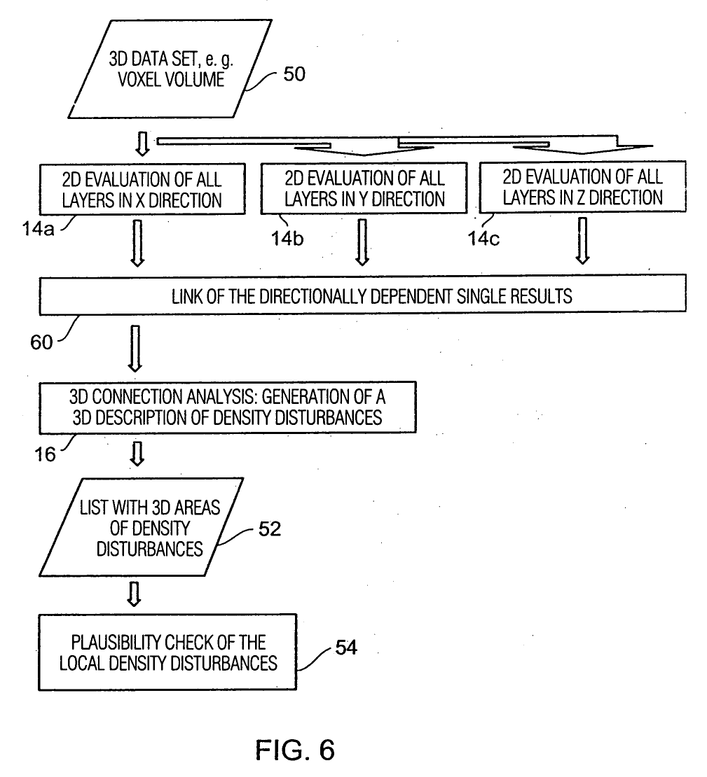

Subsequently, on the basis of FIG. 6, reference is made to a preferred embodiment of the present invention providing effective artifact reduction. In contrast to the straightforward subdivision of the three-dimensional representation along one direction, multiple subdivision is performed using two, three, or even more directions, as it is shown in FIG. 3. Then, a two-dimensional evaluation of all layers in the individual directions x, y, and z is performed (14a, 14b, 14c). Thereby, for each volume element (voxel) of the object, not only a single statement is obtained, whether a deviation in state is present here, but three pieces of information independent from each other. By a link of the direction-dependent single results, it is now possible to specify voxel-wise whether actually a deviating state is present here or an artifact was present. The link of the direction-dependent single results may either take place logically, for example by an ANDing of the three results shown in FIG. 6. Alternatively, a majority decision could also be made, i.e. if two blocks 14a to 14c show indications of a deviation in state, it is decided that here a deviation in state is present. Again alternatively, the sum of the three single results on a gray scale could be taken as link of the direction-dependent single results, and then it could be decided by means of a threshold, whether the volume element has a deviating state or not.

In particular in a layerwise evaluation of computer tomography data it has turned out that in a two-dimensional section of the computer tomography volume, flaw-like gray scale disturbances may result in the area of a correct three-dimensional structure. Such a case may for example also occur in small bores. Thus, the layerwise evaluation in three mutually orthogonal directions is applied by the embodiment shown in FIG. 6. The decision whether a volume element contains a flaw structure is made by means 60 or by one or a combination of the methods described. With this, a clear artifact reduction may be enabled. The artifact reduction is of significance especially in the present method, because the method can do without reference data and is to be employed in an automated manner, so it has not to be trusted to a double check of an operator.

The embodiment shown in FIG. 6 is also of advantage especially then when, as in the case of a computer tomography representation, the captured data as such are relatively affected by artifacts due to scatterings, multiple reflections and multiple propagations. In other cases of application in which more advantageous three-dimensional data are present, or in cases in which the computer tomography representation has already been subjected to an independent artifact reduction, the two-dimensional evaluation in one direction may already suffice, but is of course enhanced by evaluation in two, three, or more directions.

It is to be understood that the inventive concept cannot only be used for detecting faulty structures but also for detecting and measuring target structures, such as bores. Due to the connection analysis and with assumed fine layerwise division, the bore may be very accurately measured with respect to its length. The inventive concept further also allows to easily determine whether the bore is circular in a certain tolerance range or is “warped”. Finally, the inventive method may determine via neighboring areas with provision of suitable attributes whether it is a bore, namely then when the neighboring areas to the bore have a very high density value and when the bore opens toward a “background”.

Also without provision of geometric reference data about the object as such, a work piece may also be measured with reference to the constructive structure if it is being predetermined as auxiliary information that for example only bores with a particular size within a certain tolerance are allowed to be present. The inventive concept will then search the list of the three-dimensional places of deviating state provided by the three-dimensional connection analysis in order to characterize and compare, with the default target sizes, cylindrical structures indicating a bore with respect to their size.

The same is true for the case in which the object consists of two different materials, e.g. an aluminum lid, a gasket, and a further aluminum lid. In this case it may be indicated as auxiliary information that only two density values different from each other exist, wherein an area of mean density indicating a rubber gasket has to be surrounded above and below by an area of high density representing the aluminum part. Using this information, it may for example be determined whether a gasket is defective, namely if, in a particular section, an area with mean density occurs at no point.

From the previous discussion it becomes obvious that by providing suitable auxiliary information and corresponding computation of suitable attributes for the two-dimensional result list or three-dimensional result list, the inventive concept may not only be employed for the flaw detection but also for the characterization of target structures.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Apparatus for evaluating a state of an object, comprising:
means for providing a three-dimensional representation of the object including information about the state to be evaluated;
means for subdividing a three-dimensional representation into a plurality of sub-areas, wherein a sub-area includes volume elements;
means for two-dimensionally evaluating sub-area by sub-area the three-dimensional representation by examining each sub-area of the plurality of sub-areas in order to ascertain data about one or more two-dimensional places in the sub-area at which the state deviates from a default state; and
means for performing a three-dimensional connection analysis using the data about the places by tracking connected places through the individual sub-areas and linking the connected places in order to obtain a three-dimensional description of one or more three-dimensional places whose states deviate from the default state, characterized in that
the means for subdividing the three-dimensional representation into sub-areas is disposed to perform a subdivision in at least two different directions through the three-dimensional representation,
the means for two-dimensionally evaluating the sub-areas is disposed to examine the sub-areas segmented in different directions such that for each volume element of the three-dimensional representation at least two separate pieces of information about a deviating state are obtained, and
means for linking the at least two pieces of information present per volume element, which precedes the means for the three-dimensional connection analysis in order to specify by linking the pieces of information, whether a volume element includes a state deviating from the default state or an artifact.

2. Apparatus of claim 1, wherein the means for subdividing is disposed to provide a subdivision of the three-dimensional representation into a plurality of layers.

3. Apparatus of claim 1, wherein the state is the density of the object.

4. Apparatus of claim 1, wherein the means for two-dimensionally evaluating the sub-areas comprises the following sub-features:
means for obtaining a sub-area of the object together with background;
means for segmenting the two-dimensional representation of the object together with background into a plurality of segments;
means for examining the segments for deviations in state in order to separate the object from the background; and
means for marking the segments with deviations in state,
wherein the means for two-dimensionally evaluating the sub-areas operates to only evaluate the marked segments.

5. Apparatus of claim 1, wherein the means for two-dimensionally evaluating sub-area by sub-area is disposed to use a filter in examining, in order to detect a deviation in state lying over a predetermined significance threshold.

6. Apparatus of claim 5, wherein a deviation in state lying above the significance threshold includes an attribute including the geometric size, the strength of the deviation in state, information about the surroundings of the place and/or geometric information.

7. Apparatus of claim 6, wherein the means for two-dimensionally evaluating is disposed to generate a state list for each sub-area, in which places with deviating state together with their attributes are listed.

8. Apparatus of claim 1, wherein the three-dimensional representation of the object is present as an array of volume elements, and wherein each volume element in a place with deviating state is associated with an indicator including information about the deviating state of the place.

9. Apparatus of claim 1, wherein constructive deviations in state and unintentional deviations in state are present, and wherein the means for performing a three-dimensional connection analysis is connected on the output side to a means for the plausibility check, in order to distinguish a constructive deviation in state from an unintentional deviation in state.

10. Apparatus of claim 1, wherein a three-dimensional description of a three-dimensional place with deviating state that includes a plurality of volume elements, if applicable, includes an attribute including the volume, the center of gravity, a mass, a moment, a kind of the deviation in state and information about a neighborhood of the place.

11. Apparatus of claim 1,
wherein the means for linking is disposed to perform a vertical ANDing of the pieces of information, a majority decision among pieces of information and/or a summation and threshold comparison operation.

12. Apparatus of claim 1, wherein a means for the plausibility check is further provided to assess a three-dimensional description of a three-dimensional place with deviating state, wherein additional information about the object is used for assessment to distinguish constructive deviations in state from unintentional deviations in state and/or assess constructive deviations in state regarding the additional information.

13. Apparatus of claim 11, wherein the means for subdividing into sub-areas is disposed to subdivide a three-dimensional representation present as xyz volume into two-dimensional layers along the x direction, along the y direction, and along the z direction.

14. Method for evaluating a state of an object, comprising:
providing a three-dimensional representation of the object, which includes information about the state to be evaluated;
subdividing the three-dimensional representation into a plurality of sub-areas, wherein a sub-area includes volume elements;
two-dimensionally evaluating sub-area by sub-area the three-dimensional representation by examining each sub-area of the plurality of sub-areas, in order to ascertain data about one or more two-dimensional places in the sub-area at which the state deviates from a default state; and
performing a three-dimensional connection analysis using the data about the places for the individual sub-areas by tracking connected places through the individual sub-areas and linking the connected places in order to obtain a three-dimensional description of one or more three-dimensional places whose states deviate from the default state, characterized in that
in the step of subdividing the three-dimensional representation into sub-areas, a subdivision is performed in least two different directions through the three-dimensional representation,
in the step of two-dimensionally evaluating the sub-areas, the sub-areas segmented in different directions are examined such that for each volume element of the three-dimensional representation at least two separate pieces of information about a deviating state are obtained, and
before the step of conducting the three-dimensional connection analysis, the step of linking the at least two pieces of information present per volume element is performed, in order to specify, by linking the pieces of information, whether a volume element includes a state deviating from the default state or an artifact.
